(19) United States
(12) Patent Application Publication
(10) Pub. No.: US 2018/0143590 A1
(43) Pub. Date: May 24, 2018

(54) Clock

(71) Applicant: Byeong Dong Kim, Gyeonggi-do (KR)

(72) Inventor: Byeong Dong Kim, Gyeonggi-do (KR)

(21) Appl. No.: 15/569,476

(22) PCT Filed: Apr. 18, 2016
(86) PCT No.: PCT/KR2016/003996

§ 371 Date: Oct. 26, 2017

(30) Foreign Application Priority Data
May 6, 2015 (KR) 10-2015-0063261

(51) Int. Cl. G04B 19/23; G04B 19/28

(52) U.S. Cl. CPC G04B 19/23; G04B 19/283

(57) ABSTRACT

A clock according to an exemplary embodiment of the present invention includes: an hour hand part which includes a first hour hand for indicating time of a first country to be shown, and a second hour hand for indicating time of a second country to be shown; an hour hand plate which indicates times including a reference line for defining 12 am; a city name plate on which an international date line and city names are marked and which is rotated together with the first hour hand; and a date display part which displays two continuous dates based on the international date line, in which in the date display part, the date is changed as the international date line provided on the city name plate, which is rotated relative to the hour hand plate, passes over the reference line provided on the hour hand plate. The clock according to the present invention is configured as an analog-type dual clock required according to increase in overseas activity of people such as overseas travelers and people active in overseas business to present a new type for satisfying various tastes and consumption desires and also enable a user to easily recognize time and dates by showing different dates corresponding to local times of two countries.

### TECHNICAL FIELD

The present invention relates to a clock.

### BACKGROUND ART

In general, a clock indicates hours, minutes, and seconds by using an hour hand, a minute hand, and a second hand to enable a user to recognize time, and the clock also indicates time from 0 to 24 hours.

That is, typically, a mark for 12 o'clock is marked at a central upper end of the clock, a mark for 6 o'clock is marked at a central lower end of the clock rightward from the mark for 12 o'clock at a predetermined time interval from the mark for 12 o'clock, and makers for 7 o'clock, 8 o'clock, and 9 o'clock are marked at points leftward from the mark for 6 o'clock.

60 seconds are (i.e., 1 minute is) indicated when the second hand moves rightward from the mark for 12 o'clock and makes one revolution, and the minute hand moves rightward by one minute accordingly. 60 minutes are (i.e., 1 hour is) indicated when the minute hand moves rightward from the mark for 12 o'clock and makes one revolution, and the hour hand moves rightward by one hour accordingly.

12 hours are (i.e., 12 am or 12 pm is) indicated when the hour hand moves rightward from the mark for 12 o'clock and makes one revolution, and the hour hand, the minute hand, and the second hand rotate together, thereby showing time positions indicating time.

The clock is classified into a wall clock, a table clock, a watch, and the like depending on intended use and characteristics such as a space. The clock has functions such as an alarming function, or the clock is decorated with characters. In addition, the clock is classified into an analog clock and a digital clock depending on a driving principle of the clock.

In general, the clock indicates 24 hours as the hour hand makes two revolutions in a day, or a dual clock, which shows local times of two countries by changing numerals and is limited to the digital type unlike the analog type that indicates time as the hour hand moves, is just commercially available.

In particular, activities of overseas traveler and people active in overseas business are progressively increased, but the clocks, which indicate time by just changing numbers, are not purchased by users, and as a result, there is a need for developing new markets that meet demands of users with various preferences in order to enhance competitiveness, and there is a need for improvement.

### DISCLOSURE

### Technical Problem

The present invention has been made in an effort to solve the problems in the related art, and an object of the present invention is to provide a new type clock capable of satisfying various preferences and desires of consumers and improving competitiveness.

### Technical Solution

A clock according to an exemplary embodiment of the present invention includes: an hour hand part which includes a first hour hand for indicating time of a first country to be shown, and a second hour hand for indicating time of a second country to be shown; an hour hand plate which indicates times including a reference line for defining 12 am; a city name plate on which an international date line and city names are marked and which is rotated together with the first hour hand; and a date display part which displays two continuous dates based on the international date line, in which in the date display part, the date is changed as the international date line provided on the city name plate, which is rotated relative to the hour hand plate, passes over the reference line provided on the hour hand plate.

Specifically, the clock may further include a color display part which defines a color of the hour hand plate or is provided on one surface of the hour hand plate to display a color, in which the color display part displays two colors that are distinguished based on the reference line and the international date line.

Specifically, the color display part may display a first color from the reference line to the international date line clockwise, and may display a second color from the international date line to the reference line clockwise.

Specifically, the clock may further include a minute hand plate which indicates minutes, in which the hour hand plate and the minute hand plate are fixed to a frame that defines an external appearance of the clock.

Specifically, marks for hours marked on the hour hand plate and marks for minutes marked on the minute hand plate may have different diameters so that the marks for hours and the marks for minutes do not interfere on another.

Specifically, the first hour hand may be fixed to the city hour plate or configured as an indicator, and rotated together with the city hour plate.

### Advantageous Effects

The clock according to the present invention is configured as an analog-type dual clock required according to increase in overseas activity of people such as overseas travelers and people active in overseas business to present a new type for satisfying various tastes and consumption desires and also enable a user to easily recognize time and dates by showing different dates corresponding to local times of two countries.

### DESCRIPTION OF DRAWINGS

FIG. 1 is a view illustrating a state in which an international date line and a reference line of a clock according to an exemplary embodiment of the present invention are misaligned.

FIG. 2 is a view illustrating a state in which the international date line and the reference line of the clock according to the exemplary embodiment of the present invention overlap.

FIG. 3 is a view illustrating a state in which the international date line and the reference line of the clock according to the exemplary embodiment of the present invention are misaligned.

FIG. 4 is a view conceptually illustrating a state in which a configuration of the clock according to the exemplary embodiment of the present invention is disassembled.

### DESCRIPTION OF MAIN REFERENCE NUMERALS OF DRAWINGS

100: Clock
110: Hour hand part
111: First hour hand
112: Second hour hand
115: Minute hand
120: Hour plate
121: Hour hand plate
121A: Reference line
122: Minute hand plate
130: City name plate
131: International date line
140: Color display part
150: Date display part
151: First date plate
152: Second date plate

### MODES OF THE INVENTION

Other objects, particular advantages, and novel features of the present invention will be more clearly understood from the following detailed description and the exemplary embodiments with reference to the accompanying drawings. In the present specification, in denoting reference numerals to constituent elements of the respective drawings, it should be noted that the same constituent elements will be designated by the same reference numerals, if possible, even though the constituent elements are illustrated in different drawings. Further, in the following description, a detailed explanation of known related technologies may be omitted to avoid unnecessarily obscuring the subject matter of the present disclosure.

Hereinafter, an exemplary embodiment of the present invention will be described in detail with reference to the accompanying drawings.

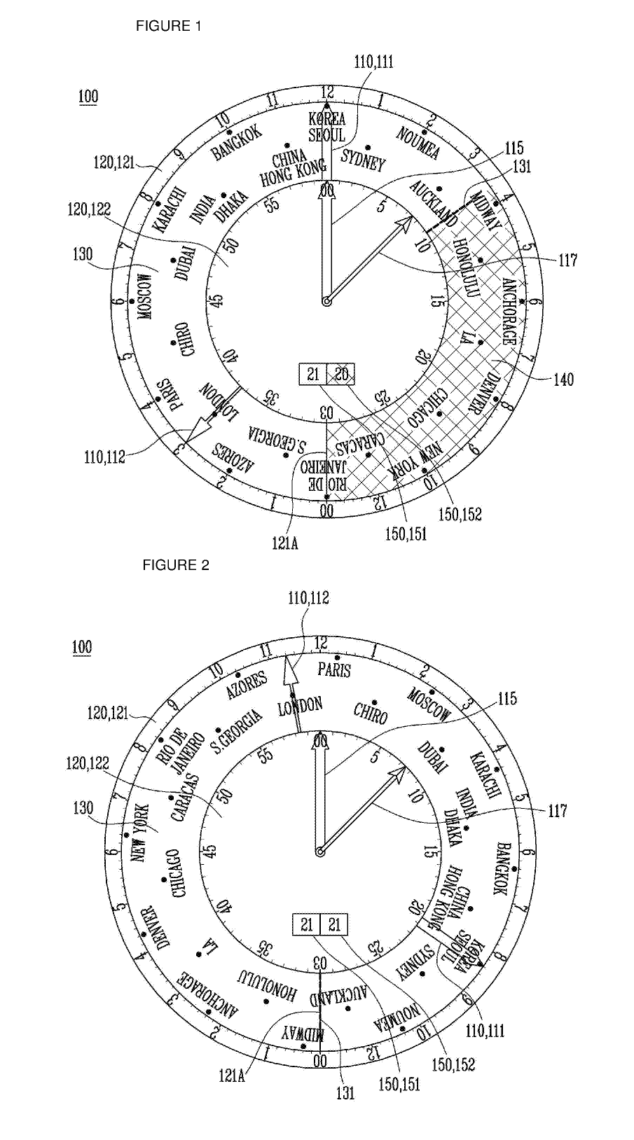

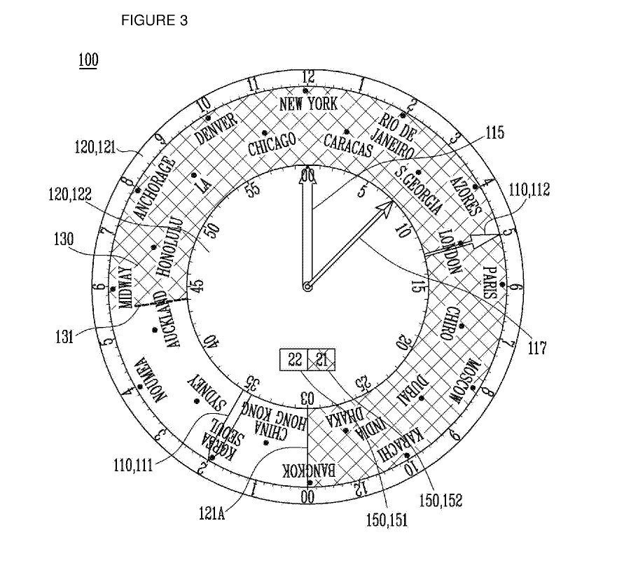

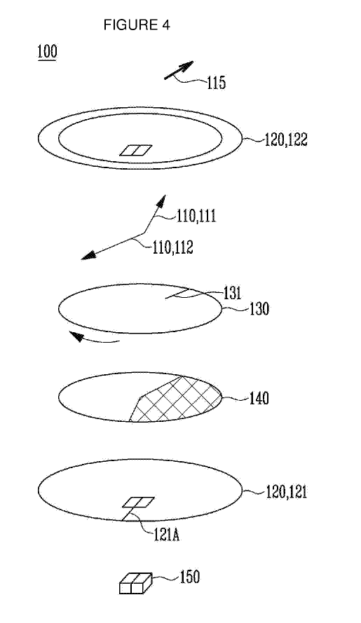

FIG. 1 is a view illustrating a state in which an international date line and a reference line of a clock according to an exemplary embodiment of the present invention are misaligned, FIG. 2 is a view illustrating a state in which the international date line and the reference line of the clock according to the exemplary embodiment of the present invention overlap, FIG. 3 is a view illustrating a state in which the international date line and the reference line of the clock according to the exemplary embodiment of the present invention are misaligned, and FIG. 4 is a view conceptually illustrating a state in which a configuration of the clock according to the exemplary embodiment of the present invention is disassembled.

As illustrated in FIGS. 1 to 4, a clock 100 according to an exemplary embodiment of the present invention includes an hour hand part 110, an hour plate 120, a city name plate 130, a color display part 140, a date display part 150, and a frame (not illustrated) and a cover (not illustrated) which accommodate these components.

Here, the components such as the hour hand part 110, the hour plate 120, the city name plate 130, and the color display part 140 are installed in the frame, the frame defines an external appearance, and the frame may be sealed by the cover. However, the cover may be transparent in order to enable a user to identify the components such as the hour hand part 110 and the hour plate 120 in the clock 100, and for example, the cover may be made of glass or the like.

The hour hand part 110 is configured to indicate hours, among hours, minutes, and seconds, in accordance with a change in time, and the hour hand part 110 may be rotated at a constant speed by being supplied with power from a power source (not illustrated), for example, a movement.

Here, the movement may be used by adopting publicly known general techniques such as mechanical techniques such as automatic (self-winding) device or a manual winding spring or electronic techniques such as quartz or a kinetic device. Of course, the movement may be connected to the components such as the city name plate 130, which requires power, as well as the hour hand part 110 through a typical structure, and the movement may operate the components.

The hour hand part 110 includes a first hour hand 111 and a second hour hand 112 in order to indicate local times of two countries where there is a time difference due to different spaces at the same time. The first hour hand 111 is rotated to indicate time of a first country to be shown, and the second hour hand 112 is rotated to indicate time of a second country.

Here, the first hour hand 111 indicates the time of the first country which is a country determined by the user, the first hour hand 111 is marked on the city name plate by transfer printing and by means of a sticker, and the first hour hand 111 may be rotated together with the city name plate 130.

In contrast, the first hour hand 111 may be configured as a separate hand like the second hour hand 112, and may be rotated. The reason is to enable the user to select the countries indicated by the first hour hand 111 and/or the second hour hand 112.

In addition, there may be a time difference of N (natural number) hours between the two countries of which the times are indicated, or there may be a time difference of N (natural number) hours and M (natural number) minutes. That is, in a case in which the time difference is N (natural number) hours and M (natural number) minutes, the components of the time difference between the first country and the second country include hours and minutes, and as a result, the minute hand 115 may be divided into two pieces, similar to the hour hand part 110. Because the minute hand 115 has the same mechanism as the hour hand part 110, a repeated description will be omitted. However, unlike the hour hand part 110, the minute hand 115 is configured to make one revolution for 60 minutes (1 hour). In addition, non-described reference numeral 117 may indicate an hour hand 117 or a minute hand for the second country.

Further, the hour hand part 110 and the minute hand 115 may have publicly known various shapes such as a bar and an arrow, and various modified examples may be made in which the first hour hand 111, the second hour hand 112, and the minute hand 115 are distinguished based on colors such as chroma, brightness, transparency, markings such as letter or symbols, shapes, forms, or the like.

However, in the present exemplary embodiment, among hours, minutes, and seconds, the hours may be indicated adjacent to an outer periphery of the frame, and the minutes may be indicated adjacent to a center of the frame. In this case, to enable the user to easily recognize the hours, the hour hand part 110 may be longer than the minute hand 115 so that the hour hand part 110 may be close to an indicator such as a graduation for indicating hours.

Times are marked on the hour plate 120 to allow the hour hand part 110 and the minute hand 115 to indicate time, and the hour plate 120 may include an hour hand plate 121 for indicating hours among hours, minutes, and seconds.

Times are indicated, including a reference line 121A for defining 12 am, by the hour hand plate 121. The hour hand plate 121 may be equally divided into 24 pieces along a circumference of a circle in order to identify times indicated by the hour hand part 110 that makes one revolution in a day. Here, the reference line 121A defines 12 am at a point in time that changes from pm (night) to am (day), and the reference line 121A may mean a reference, based on which the date is changed.

As an example, the hour hand plate 121 is fixed to the frame that defines an external appearance of the clock 100, and the minute hand plate 122 of the hour plate 120, which indicates minutes, may be provided to be fixed to the frame separately from the hour hand plate 121. In contrast, the hours and the minutes may be marked together on the hour hand plate 121, but in the present exemplary embodiment, an example in which the hour hand plate 121 and the minute hand plate 122 are separately provided will be described.

That is, the hours and the minutes may be separately indicated by the hour hand plate 121 and the minute hand plate 122, or the hours and the minutes may be separately indicated to enable the user to recognize time regardless of the configuration in which the hours and the minutes are marked together on the hour hand plate 121. For example, the hours and the minutes may be indicated by various forms such as graduations (for example, figures, dots, or lines), symbols (for example, Arabic numerals or Roman alphabets), or a combination thereof, and the hours and the minutes may be distinguished by various forms such as thicknesses, lengths, and sizes.

In the present exemplary embodiment, the hour hand plate 121 and the minute hand plate 122 are separately configured, and the hour hand plate 121 and the minute hand plate 122 may be structured to be stacked vertically in a line on the frame. Here, unlike the configuration in which the hour hand indicates the numbers 1 to 24 (in the clock according to the present exemplary embodiment, the hour hand may separately indicate 24 hours as the hour hand makes one rightward revolution in a day), the minute hand and the second hand equally indicate the numbers 1 to 60 to indicate time, and as a result, the minute hand plate 122 may be used as an indicator of the second hand. In this case, the minute hand 115 and the second hand may have different thicknesses or lengths to distinguish minutes and seconds, or the second hand may be omitted.

The hour hand plate 121 and the minute hand plate 122 are fixed together to the frame so as to be spaced apart from each other vertically so that the hour hand part 110 and the minute hand 115 do not interfere with each other. Here, the hour hand plate 121 and the minute hand plate 122 may have portions on which the hours, the minutes, and the seconds are marked and have different diameters in order to enable the user to easily recognize the hours, the minutes, and the seconds.

As an example, the hour hand plate 121 may be provided on which the hours are marked along a circumference of a circle having a first diameter, and the minute hand plate 122 may be provided on which the minutes are marked along a circumference of a circle having a second diameter smaller than the first diameter.

In this case, there is no limitation to the order in which the hour hand plate 121 and the minute hand plate 122 are stacked vertically, but the hour hand plate 121 having the first largest diameter on which the hours are marked may be provided at a lower side and the minute hand plate 122 having the second diameter on which the minutes are marked may be provided above the hour hand plate 121 so that the marks marked on the hour hand plate 121 and the minute hand plate 122 do not interfere with the adjacent hour hand plate 121 and the adjacent minute hand plate 122. Further, a region from an outer periphery of a minute indication part to an hour indication part may be transparent in order to prevent the hour indication part of the hour hand plate 121 from being covered by the minute hand plate 122.

On the contrary, the hour hand plate 121 is provided above the minute hand plate 122, and the hour hand plate 121 may be transparent at the minute indication part in order to prevent the minute indication part of the minute hand plate 122 from being covered.

Here, the marks for indicating time on the hour hand plate 121 and the minute hand plate 122 may be formed by various printing and plating methods, for example, a publicly known transfer printing method (method of transferring a film printed on paper to a surface), an off-set printing method (method of transferring an image to a rubber blanket and printing the image on a sheet), and a screen printing method (method of printing an image by covering a non-streak portion of a screen such as silk with stencil glue and putting ink on the screen to allow the ink to pass through a streak portion of the screen).

In this case, the minute hand plate 122 may be used as a plate for simultaneously indicating the minute hand and the second hand. That is, in the present invention, the minute hand plate 122 may indicate the minute hand and/or the second hand.

The city name plate 130 is configured to display cities of which the time is required to be ascertained, city names are marked on the city name plate 130, that is, a plurality of countries in addition to the first and second countries is marked on the city name plate, and the second country may be selectively changed in accordance with the user's selection. In this case, the second hour hand 112 may be rotated to the city name corresponding to a change in second country, and this may be generally performed by moving the second hour hand 112 to a position which is indicated by the second hour hand 112 by performing an operation identical to the operation of changing time indicated by the hour hand.

The city name plate 130 is rotated together with the first hour hand 111 and operates in conjunction with the time of the first country indicated by the first hour hand 111, the city name plate 130 is rotated by a driving source, and the rotation of the city name plate 130 may be performed by the same mechanism as the rotation of the first hour hand 111.

In addition to the city names, an international date line 131 is marked on the city name plate 130. The international date line 131 marked on the city name plate 130 may be an indicator configured as a mark, and a date change between the first country and the second country is detected based on the international date line 131, such that the date displayed on the date display part 150 may be changed. The international date line 131 may be visible to the user's eyes.

The color display part 140 displays a zone including several cities in the corresponding date in conjunction with the date display part 150 and in accordance with colors of the date display part 150, such that when the city is positioned at a date indicated in a color, the date of the city corresponding to the color is identical to the date indicated in the same color of the date display part 150, thereby enabling the user to intuitively and immediately recognize the city and the date.

That is, the color display part 140 may display two colors which are distinguished based on the reference line 121A and the international date line 131. Specifically, the color display part 140 displays a first color from the reference line 121A to the international date line 131 clockwise, and displays a second color from the international date line 131 to the reference line 121A clockwise.

The color display part 140 displays the two colors based on the reference line 121A and the international date line 131 by detecting the reference line 121A and the international date line 131. As an example, the color display part 140 includes a sensor (not illustrated) and a control unit (not illustrated), such that the sensor transmits a signal to the control unit when the sensor detects a change of the reference line 121A and the international date line 131, and the color of the color display part 140 may be changed by the control unit.

Here, the color display part 140 may define a color of the hour hand plate 121. In contrast, the color display part 140 in the form of a separate plate is provided on a lower or upper surface of the hour hand plate 121 to display the color. Here, the color of the color display part 140 may be displayed and changed in a digital manner. That is, the color display part 140 may be integrated with the hour hand plate 121.

However, in the present invention, the color display part 140 may be omitted. That is, the user may recognize the date by using the reference line 121A of the hour hand plate 121 and the international date line 131 of the city name plate 130 without using the color display part 140.

The date display part 150 is provided with a first date plate 151 which indicates a date of the first country indicated by the first hour hand 111, and a second date plate 152 which indicates a date of the second country indicated by the second hour hand 112.

Here, the dates indicated by the first and second date plates 151 and 152 are different dates corresponding to the cities in the first and second countries, and the dates are displayed in different colors to enable the user to recognize the dates. In contrast, in a case in which the date of the first country and the date of the second country are identical to each other such as when the first country and the second country are in the day and night times, respectively, the date of the first country and the date of the second country may be indicated in the same color. In the date display part 150, the date is changed as the international date line 131 passes over the reference line 121A.

That is, in the date display part 150, the date may be changed as the international date line 131, which is provided on the city name plate 130 that rotates relative to the hour hand plate 121, passes over the reference line 121A provided on the hour hand plate 121.

As described above, the date display part 150 forms the clock 100 for indicating two dates, such that the date is changed when the international date line 131 passes over 0 am (12 am). For example, the date is not changed when the first hour hand 111 passes over 0 am, but the date may be changed when the international date line 131 passes over 0 am. As such, it is possible for the user to simultaneously recognize dates and times of the respective cities.

In addition, in the present exemplary embodiment, in addition to the dates, days of week corresponding to the dates are marked on the date display part 150, the days of week may of course be changed in conjunction with the change in date, and the day of week is changed in the same mechanism as the date.

Furthermore, various exemplary embodiments may be implemented such as an exemplary embodiment in which 365 days are inputted to the first date plate 151 and the second date plate 152, such that the dates are automatically changed in accordance with a change in date, and an exemplary embodiment in which the user may directly input the first days of new months in accordance with the last days of the months, such as 28th, 29th, 30th, and 31st days, which are different from one another.

Furthermore, the date of the first date plate 151 and the date of the second date plate 152 are indicated in the same color when the date of the first date plate 151 and the date of the second date plate 152 are identical to each other, but the date of the first date plate 151 and the date of the second date plate 152 may be indicated in different colors (for example, complementary or opposite colors such as red and blue), when the date of the first date plate 151 and the date of the second date plate 152 are different from each other and two continuous dates.

When specifically describing the present invention with reference to the drawings, as illustrated in FIG. 1, the date display part 150 displays two dates, in which the current date of the cities positioned counterclockwise based on the international date line 131 is a 21st day, and the current date of the cities positioned clockwise based on the international date line 131 is a 20th day. That is, a day is reduced by crossing the international date line 131 clockwise.

However, when about 8 hours are elapsed from the time illustrated in FIG. 1, the international date line 131 overlaps the reference line 121A as illustrated in FIG. 2. In this case, the date of all of the countries is a 21st day. That is, the date display part 150 may display the same two dates, the 21st day. That is, a day is added only to the date indicated at the right side of the date display part 150.

When the time has passed and the international date line 131 moves clockwise from the reference line 121A as illustrated in FIG. 3, the date display part 150 displays two different dates. In this case, a day is added only to the date indicated at the left side of the date display part 150, and the dates displayed by the date display part 150 are 22nd and 21st days.

That is, a day is added to the date indicated at the right side of the date display part 150 when the international date line 131 overlaps the reference line 121A, and a day is added to the date indicated at the left side of the date display part 150 when the international date line 131 moves clockwise from the reference line 121A.

The clock 100 is configured as an analog type clock and made as a real article in which the hour hand part 110, the hour plate 120, the city name plate 130, and the color display part 140 are made of metal, plastic, or a material corresponding to metal and plastic, and the clock 100 may operate.

In contrast, the clock 100 may be configured in a digital manner in which the hour hand part 110, the hour plate 120, the city name plate 130, and the color display part 140 are displayed in a digital manner on a display, but the user may recognize the clock having an analog shape.

In addition, the clock 100 may be configured in a combination of the analog manner and the digital manner, and as an example, the hour plate 120 and the city name plate 130, which are rotated in the frame, may be configured in the mechanical and analog manner, and the color display part 140 may be programmed to change color.

The hour hand part 110 and the city name plate 130 may be physically rotated by the driving source in the analog manner, while the rotations of the hour hand part 110 and the city name plate 130 may be recognized by the user through a change in color on the display in the digital manner.

That is, in the present exemplary embodiment, the materials, the shapes, and the mechanisms of the respective components are not limited, and times of two or more countries are separately indicated, such that it is possible for the user to easily recognize different dates of the respective countries.

The clock according to the present invention is configured as an analog-type dual clock required according to increase in overseas activity of people such as overseas travelers and people active in overseas business to present a new type for satisfying various tastes and consumption desires and also enable a user to easily recognize time and dates by showing different dates corresponding to local times of two countries.

While the present invention has been described in detail with reference to the specific exemplary embodiment for specifically explaining the present invention, the present invention is not limited to the exemplary embodiment, and it is apparent that the alteration or modification may be made by those skilled in the art without departing from the technical spirit of the present invention.

The simple modification and alteration of the present invention are within the scope of the present invention, and the specific protection scope of the present invention should be clearly defined by the appended claims.

1. A clock comprising:
an hour hand part which includes a first hour hand for indicating time of a first country to be shown, and a second hour hand for indicating time of a second country to be shown;
an hour hand plate which indicates times including a reference line for defining 12 am;
a city name plate on which an international date line and city names are marked and which is rotated together with the first hour hand; and
a date display part which displays two continuous dates based on the international date line,
wherein in the date display part, the date is changed as the international date line provided on the city name plate, which is rotated relative to the hour hand plate, passes over the reference line provided on the hour hand plate.

2. The clock according to claim 1, further comprising:
a color display part which defines a color of the hour hand plate or is provided on one surface of the hour hand plate to display a color,
wherein the color display part displays two colors that are distinguished based on the reference line and the international date line.

3. The clock according to claim 2, wherein the color display part displays a first color from the reference line to the international date line clockwise, and displays a second color from the international date line to the reference line clockwise.

4. The clock according to claim 1, further comprising:
a minute hand plate which indicates minutes,
wherein the hour hand plate and the minute hand plate are fixed to a frame that defines an external appearance of the clock.

5. The clock according to claim 4, wherein marks for hours marked on the hour hand plate and marks for minutes marked on the minute hand plate have different diameters so that the marks for hours and the marks for minutes do not interfere on another.

6. The clock according to claim 1, wherein the first hour hand is fixed to the city name plate or configured as an indicator, and rotated together with the city name plate.
